(19) United States
(12) Patent Application Publication
(10) Pub. No.: US 2015/0134567 A1
(43) Pub. Date: May 14, 2015

(54) EMPLOYEE STOCK OWNERSHIP PLAN (ESOP) MANAGEMENT SYSTEM AND METHOD

(71) Applicant: 4J Technologies, Inc., Caseyville, IL (US)

(72) Inventors: James D. Maher, Caseyville, IL (US); Jacob J. Hong, Caseyville, IL (US)

(21) Appl. No.: 14/539,668

(22) Filed: Nov. 12, 2014

Related U.S. Application Data
(60) Provisional application No. 61/902,640, filed on Nov. 11, 2013.

(51) Int. Cl. G06Q 40/06

(52) U.S. Cl. CPC G06Q 40/06
USPC 705/36 R

(57) ABSTRACT

Computer-implemented systems and methods operate a customized financial product plan for a sponsoring company. A rules engine executes rules to determine insurance coverage limit data for product plan participants based on available insurance coverage. In addition, a web-based program gathers current status data related to customized financial products, and yields a remaining balance able to be deposited without exceeding FDIC account limits.

### BACKGROUND

The assets of an Employee Stock Ownership Plan (ESOP) are typically comprised of stock of the sponsoring company, generally referred to as employer securities, as well as non-stock assets. The employer securities and non-stock assets are allocated among the accounts of participants. The amount of each allocated to a particular account depends on, for example, whether the employee was a participant when stock of the ESOP was purchased by or contributed to the ESOP trust. An ESOP is an employee pension benefit plan, the assets of which are not directed by participants but are controlled by a plan administrator.

Some ESOPs rebalance accounts periodically so that all participants have a proportionate amount of employer securities and non-stock assets. When a distribution is made to an ESOP participant after termination of employment or upon some other event, the ESOP typically will use non-stock assets in the ESOP trust to make the distribution. The funds that are distributed will either come from cash on hand in the ESOP trust, through the liquidation of other investments held by the ESOP trust, or through a redemption of employer securities in the ESOP by the sponsoring company. Upon a distribution to a terminated participant, the remaining assets of the ESOP trust will be reallocated among the current participants in proportion to account balances. This may result in a shift of the proportion of employer securities and non-stock assets among participants, which is analogous to a trustee reallocating investments in any other defined contribution plan that does not feature self-directed accounts.

The Federal Deposit Insurance Corporation (FDIC) provides insurance coverage for employee benefit plan accounts. The FDIC regulations state that “employee benefit plan” has the same meaning as in ERISA Section 3(3). When the participants' interests in the employee benefit plan accounts are ascertainable and non-contingent, the FDIC will insure each participant's account up to $250,000. This is known as “pass-through coverage” because the coverage passes through the employer that established the account to the employee who is considered owner of the funds.

A financial product is needed for use by ESOPs to address repurchase liability, i.e., the financial obligation the plan or company incurs when an employee separates from service and his or her stock held in the ESOP must be purchased. In addition, a system is needed for managing such ESOP trusts and advising ESOP trustees and the like as to the amount of securities and other financial products that can be purchased based on current FDIC exposure for plan participants.

### SUMMARY

Aspects of the present invention address ESOP repurchase liability with structured certificates of deposit (structured CDs) as an option for ESOP trustees when investing non-stock assets. In addition, aspects of the present invention optimize investing of non-stock assets in the ESOP trust that are invested in a deposit account at an insured depository institution eligible for FDIC insurance coverage up to the standard maximum deposit insurance amount. In an aspect, a computer-implemented method operates a customized financial product plan for a sponsoring company. Software instructions stored on a memory and executable by a processor identify available insurance coverage to the participants of a customized financial product plan, collect census data related to the participants of the plan, determine a maximum balance able to be held, execute rules for determining insurance coverage limit data for product plan participants based on the identified coverage, gather current status data related to customized financial products, and yield a remaining balance able to be deposited without exceeding FDIC account limits.

In another aspect, software instructions are stored on one or more tangible, non-transitory computer-readable media and are executable by a processor.

In another aspect, a computer-implemented system including a user interface, a processor, and a memory device coupled to the processor executes the computer-executable instructions.

In another aspect, a system provides for the operation of a customized financial product plan and comprises a database, a computer implemented user interface, a rules engine, a third-party administrator reporting processing module, and a web-based program.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a flow diagram illustrating one example of processor-executable operations for assessing FDIC exposure according to an embodiment of the invention.

FIG. 2, FIG. 3, and FIG. 4 are examples of FDIC insurance coverage for an employee benefit plan according to an embodiment of the invention.

FIG. 5 is an exemplary screenshot depicting a view of a dashboard display according to embodiments of the invention.

FIG. 6 is a functional diagram depicting relations between various databases according to embodiments of the invention.

FIG. 7, FIG. 8, and FIG. 9 are additional exemplary screenshots depicting views of dashboard displays according to embodiments of the invention.

FIG. 10 is a block diagram illustrating functionally related components according to one embodiment of the invention.

FIG. 11 is a block diagram illustrating one example of a suitable computing system environment in which the invention may be implemented.

Corresponding reference characters indicate corresponding parts throughout the drawings.

### DETAILED DESCRIPTION

The interests of each participant in an ESOP are ascertainable and non-contingent because the value of each participant's account is definitely determinable. These interests are non-forfeitable, subject only to the vesting rules of the ESOP. In any employee benefit plan in which assets are invested in a general trust fund, the participants have no identifiable interest in specific assets within the fund. However, a participant's interest in the fund as a whole is ascertainable. The same is true with respect to the non-stock assets in the ESOP. Consequently, the interest in the non-stock assets of the ESOP trust would be non-contingent in the same manner as assets in another trustee-invested defined contribution plan.

When an employee who participates in an ESOP separates from service with the sponsoring company, the ESOP or the company will be required to purchase the employee's shares. This creates what is known as ESOP repurchase liability. Aspects of the invention relate to a financial product to assist sponsoring companies and ESOP trustees with the funding of future ESOP repurchase liabilities. In one embodiment, a structured product with a bank has earnings tied to market indexes and the principal is guaranteed by the bank and FDIC insured. The potential earnings can be shared between the bank and the account owner. For example, a structured certificate of deposit (CD) or principal protected market-linked CD embodies aspects of the invention. A structured CD has returns tied to selected underlying market indices and is backed by FDIC insurance. If held to maturity, return of the initial principal investment is guaranteed.

The FDIC insures eight categories of deposits: (1) single accounts; (2) certain retirement accounts; (3) joint accounts; (4) revocable trust accounts; (5) irrevocable trust accounts; (6) employee benefit plan accounts; (7) corporation/partnership/unincorporated association accounts; and (8) government accounts. An account owner's deposits are insurable up to the standard maximum deposit insurance amount (SMDIA), namely, $250,000 per bank.

In a first scenario, a company sponsoring the ESOP invests in a structured CD with the general assets of the company and retains the structured CD in the name of the company. In other words, the structured CD is considered to be held in a corporation account. The deposit accounts of a corporation at any single bank are added together and insured up to the SMDIA $250,000 in the aggregate. Deposits owned by corporations, partnerships, and unincorporated associations, including for-profit and not-for profit organizations, are insured under the same category. These deposits are insured separately from any accounts of the organization's owners, stockholders, partners, or members. It is important to note, however, that $250,000 is the maximum amount of coverage for all of a corporation's deposits in the same insured depository institution. Therefore, to maximize its FDIC coverage, a company would want to invest in a structured CD with a bank in which it has no other deposits and limit the amount of such investment to $250,000.

In a second scenario, the ESOP trust invests in a structured CD. The deposit qualifies as one belonging to an employee benefit plan account but the insurance coverage is limited to $250,000 per plan per bank without pass through coverage.

If individual employees have ascertainable, non-contingent interests in the plan, FDIC insurance for employee benefit plan accounts is considered “pass-through coverage” because the coverage passes through the entity that established the account to the employee who is considered owner of the funds. Each employee's account is then insurable up to $250,000 per bank. The value of an employee's interest shall be deemed to be the employee's account balance as of the date of default of the insured depository institution.

For plan accounts eligible for pass-through coverage, the percentage of plan assets owned by the employee with the largest account determined the maximum amount the plan can deposit at one bank and be fully insured. Aspects of the invention include determining a maximum amount a plan can deposit at one bank while providing full insurance coverage for all participants according to: $250,000 divided by X (where X represents the largest percentage of plan assets owned by a single shareholder). For example, in a plan that has assets evenly distributed over many participants and in which the largest account only represents 10 percent of the total assets, the total deposit could be as much as $2,500,000 and would be fully insured (i.e., $250,000 divided by 0.10). In any case where no participant's interest in the deposit account exceeds $250,000, the deposit would be fully insured regardless of amount.

If one employee owns a larger percentage than in the example above, the amount that could be deposited at one bank while all the assets remain fully insured would be significantly less. For example, if 75 percent of the assets are allocated to one employee, the maximum deposit amount to guarantee full insurance coverage to all participants is $333,333.34 ($250,000 divided by 0.75).

The maximum a plan can deposit and have the deposit fully insured differs from the computation of the actual insurance coverage on the deposit. When the deposit exceeds the maximum deposit amount described above, the employee accounts with a relative interest in the deposit account of less than $250,000 will be fully insured, but any employee with more than $250,000 will only be insured up to that amount. For example where one employee has a 75 percent interest and total deposits equal $400,000, the actual insurance coverage would be $350,000. Only $50,000 of the deposit allocated to the employee with a 75% interest in the plan would remain uninsured, and the other employee balances would be fully insured. As indicated above, in this situation, deposits would have to be less than $333,333.34 in order to insure full insurance coverage for all participants. Therefore, if one employee's interest in the portion of the plan invested in insured deposits exceeds $250,000, the plan administrator may want to consider purchasing structured CDs or making deposits at multiple banks to maximize the insured amount.

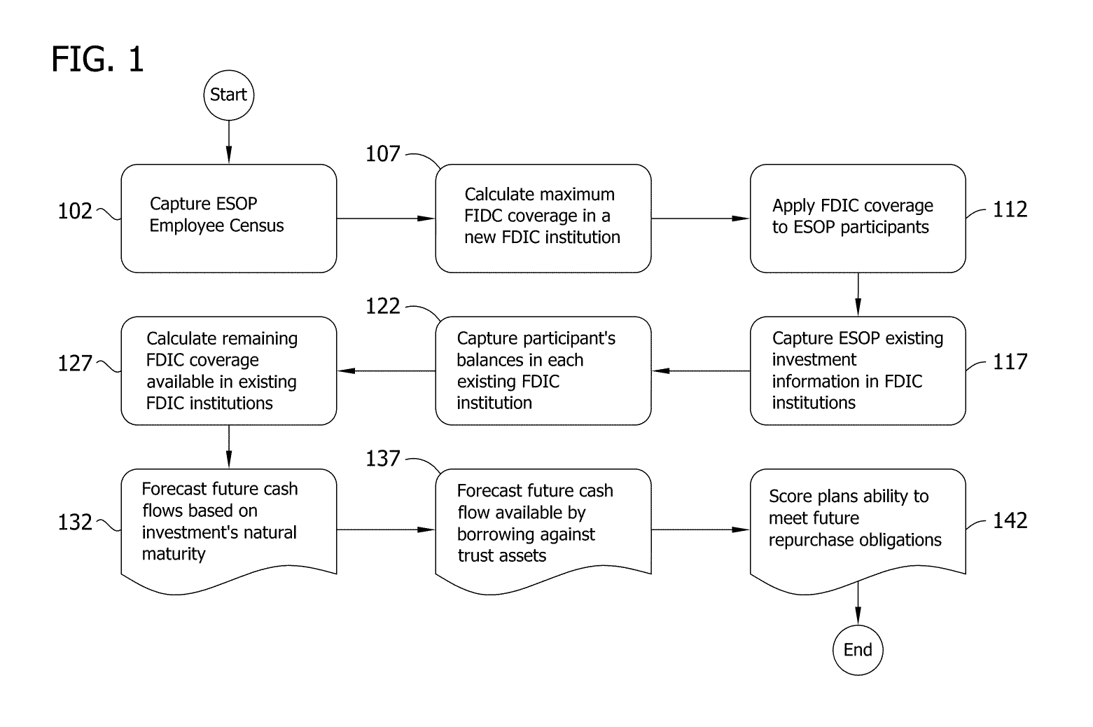

Referring to FIG. 1, software instructions stored on a tangible, non-transitory media (e.g., a memory device) and executable by a processor provide an ESOP FDIC Coverage Application embodying aspects of the invention. As shown, operations begin at 102 by capturing employee census data, such as ownership % of ESOP trust, employee age, Social Security number, date of birth, date of hire, total number of participants, etc. In an embodiment, a census is performed on the calendar year. Next, at 107, the processor executes instructions for calculating a maximum balance that could be held at an FDIC financial institution without exceeding FDIC account limits, i.e., $250,000/largest owner's % of the ESOP trust. Note that the largest owner can change from year to year or the largest owner's percentage can change from year to year, which changes the available FDIC limits available each year. Next, at 112, the processor executes instructions for applying the FDIC coverage limits to each participant in the ESOP trust and, at 117, capturing existing trust balances and maturity dates of products held in each unique FDIC financial institution and, at 122, capturing each participants associated balances. Note that maturity dates will identify liquidity of underlying investments.

Next, at 127, the processor then executes instructions for calculating the remaining balance available to deposit and still be under FDIC coverage in each of the FDIC financial institutions where ESOP trust funds are held ($250,000 minus the largest owner balance in each FDIC financial institution)/largest owner %=remaining balance available to deposit and still be under FDIC coverage. Future cash flow is then forecasted at 132 based on the investment's natural maturity, and future cash flow available by borrowing against trust assets is forecasted at 137. Finally, the plan's ability to meet the repurchase obligations is scored at 142. In an embodiment, forecasted future cash flows in the calendar years are aligned to the repurchase obligations using maturity date but do not include any market gains

In an aspect, a corporation can also benefit from the FDIC coverage and have a separate “account” to track coverage.

Embodiments of the present invention comprise a special purpose computer including a variety of computer hardware, as described in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Below are examples of FDIC insurance coverage for an employee benefit plan. All of the examples have the following common elements:
Each example has a plan with 10 participants.
The account of each participant includes company stock and other assets. The proportion of company stock in each participant account is not identical. This is typical of a mature ESOP.
The proportion of non-stock assets invested in structured CDs is identical for all participants.
The examples assume that all of the investments in the structured CDs are in a single bank and that none of the participants' other non-stock investments are held in that bank.
The reference to “Maximum Guaranteed Coverage” is the maximum amount that a plan can invest in one bank and obtain full coverage for all plan participants.

For simplicity, the examples do not consider the use of multiple banks to increase the limits of FDIC coverage.

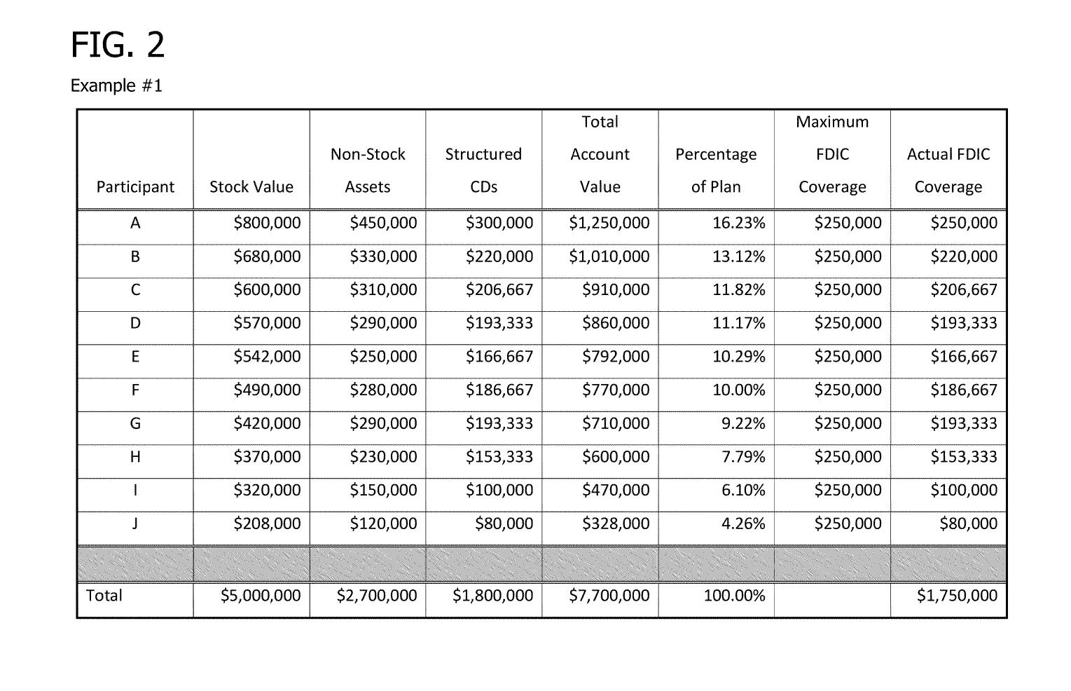

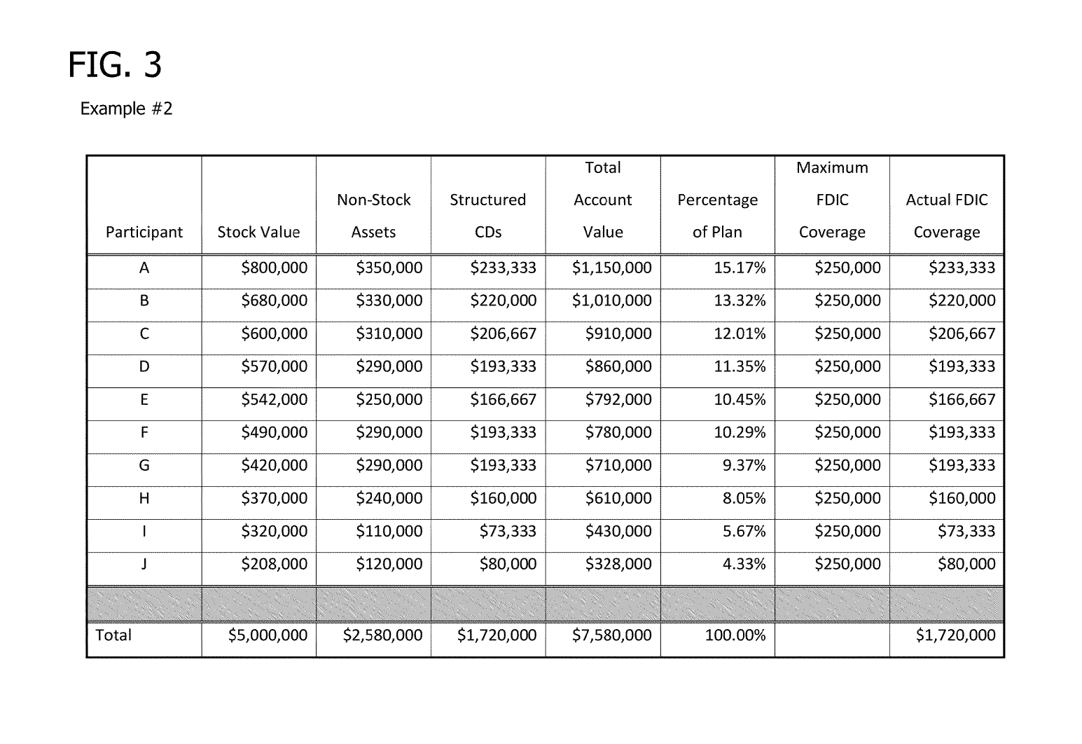

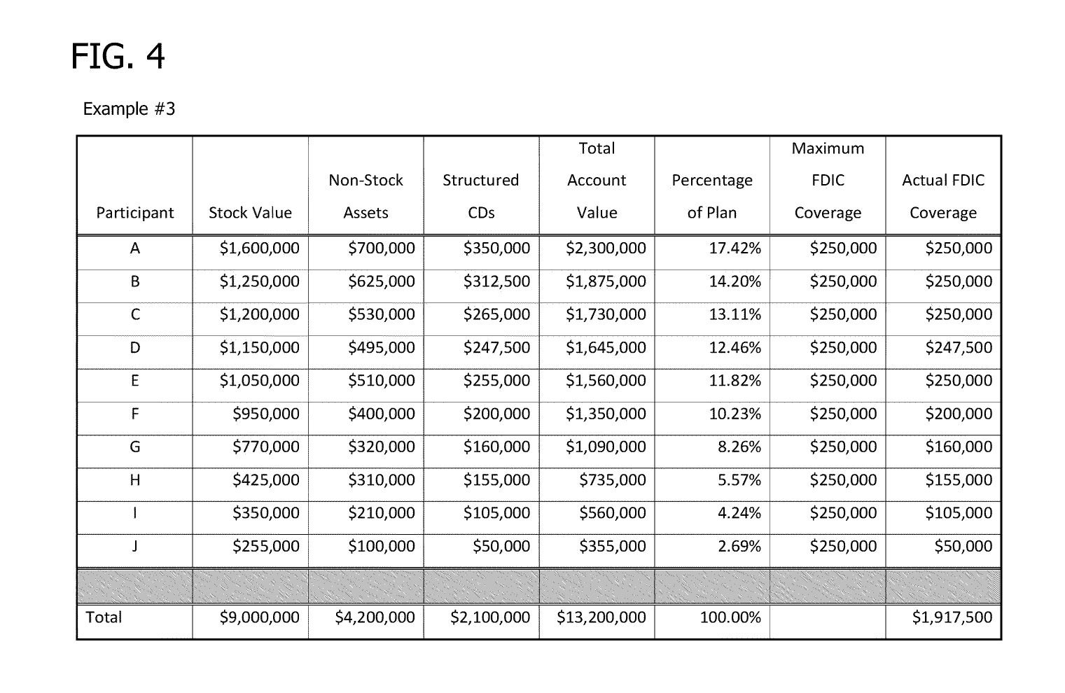

FIG. 2 illustrates Example #1. In this example:
Structured CDs represent ⅔ of the non-stock assets in the plan.
The participant with the largest account has $300,000 of structured CDs allocated to his account.
Of the $1,800,000 invested in structured CDs, FDIC insurance coverage of $1,750,000 will be provided to the plan. The coverage with respect to the account of the largest participant will be limited.

In Example #1, referring to maximum plan coverage:

Maximum Plan Coverage

| | |
|---|---|
| FDIC SMDIA | $250,000 |
| Largest Owner’s Account | 16.67% |
| Maximum Guaranteed Coverage | $1,500,000 |

FIG. 3 illustrates Example #2. In this example:
Structured CDs represent ⅔ of the non-stock assets in the plan.
The participant with the largest account has $233,333 of structured CDs allocated to his account.
The entire $1,720,000 invested in structured CDs will receive FDIC insurance coverage (even though the maximum guaranteed coverage is $1,647,826).

In Example #2, referring to maximum plan coverage:

Maximum Plan Coverage

| | |
|---|---|
| FDIC SMDIA | $250,000 |
| Largest Owner’s Account | 13.57% |
| Maximum Guaranteed Coverage | $1,842,857 |

FIG. 4 illustrates Example #3. In this example:
Structured CDs represent ½ of the non-stock assets in the plan.
Two participants with the largest account have in excess of $250,000 in structured CDs allocated to their accounts.
Of the $2,100,000 invested in structured CDs, FDIC insurance coverage of $1,917,000 will be provided to the plan. The coverage with respect to the account of the two largest participants will be limited.

In Example #3, referring to maximum plan coverage:

Maximum Plan Coverage

| | |
|---|---|
| FDIC SMDIA | $250,000 |
| Largest Owner’s Account | 16.67% |
| Maximum Guaranteed Coverage | $1,500,000 |

In an aspect, the invention provides a proprietary customized financial product that is 100% principal protected and FDIC insured. Such product is advantageously tied to specific industries or commodities. Additionally, the product is configured such that a bank can provide asset-based lending at a higher degree of liquidity than is typically available for products of this nature (75-80%). Preferably, the product is issued in a time sensitive manner on, for example, a monthly basis that requires that the plan fiduciary knows about investment capacity on a timely manner—so that the fiduciary knows whether or not he or she can commit capital to the offering. As described below, a software system embodying aspects of the invention provides an efficient solution to the plan fiduciary.

A unique feature of this product is that it is custom designed for the ESOP repurchase obligation market. This is a growing multi-billion dollar market. This product will enable plan trustees to invest in products that will mirror their future obligations for their retiring, deceased or disabled employees. Another unique feature is that these investments have a liquidity feature that enables the trustee to borrow against the assets in the retirement account (which is unique to an ESOP retirement plan) for liquidity if that need should arise before the maturity of the product.

The structure of the product is important to plan trustees. Currently, many trustees or CFO's have few options for investing the cash that is in the plan that is intended to address the repurchase obligation (in this interest rate environment where a five year CD generates 0.8% interest). Therefore most trustees have been reluctant to do anything with the cash. This decision to do nothing with the cash causes a drag on the company's overall investment performance and in an inflationary environment (3% inflation=three percent less repurchasing power) can actually cause a negative return on these assets (i.e., −3%). This outcome is concerning, especially when the cash was set aside to match a repurchase obligation that may be growing if the company is performing well (i.e., +10% company growth=a higher repurchase obligation for the ESOP trust to the participant). This product is preferably matched to stock market indexes that may be more reflective of the company's performance; therefore, keeping the company better positioned to meet their future repurchase obligations.

This product also now provides a larger incentive for the CFO's to move assets off the balance sheet into the ESOP trust to address the repurchase obligation. The movement of the assets into the ESOP trust allows the plan fiduciary to take advantage of the pass through attributes of the FDIC insurance to the participants.

In addition, to creating this investment product, aspects of the present invention provide a software product that enables the trustee to track at the participants level their exposure to any financial institutions cumulative FDIC insurance caps. This determination is important to the fiduciary since these products will become available on a monthly basis and then the offering expires. Programming is important to the trustee or CFO so that they will know the exact amount they could potentially participate in for any of the FDIC offerings so that they will not exceed their caps.

According to aspects of the invention, the product has a unique liquidity feature. In an embodiment, each issue with 100% principal protection has an asset based lending feature through Archford Capital that enables investment holders to borrow against the securities up to 75% of the asset market value. This feature allows ESOP trust fiduciaries to invest without the fear of meeting their repurchase obligations (if the timing of the obligation does not perfectly match their repurchase obligation studies). In one embodiment, this product has unique labeling that makes the market aware of the liquidity feature (e.g., Archford Capital FDIC Ser July 2017 JPM . . . ).

As described above, a financial product and software service embodying aspects of the invention assists trustees, chief financial officers (CFOs), and the like in managing their repurchase obligations for ESOP stock when individuals die, become disabled, retire, or simply separate from service with the organization. In an embodiment, the financial product is a proprietary product that can be privately labeled for Archford Capital and possesses some unique liquidity characteristics. The product is an FDIC insured, principle protected, structured product. Moreover, the product has unique liquidity features that provide an asset-based lending capability that enables the trustee to hold the asset to maturity. Advantageously, the product is tied to market performance (i.e., S&P versus a stated interest rate). Although there is a secondary market for this type of security, it is thinly traded and the investments would typically sell at a discount if they would be sold on the open market prior to maturity. Providing liquidity for these products (LIBOR-based lending rate—ability to borrow up to a certain percentage (i.e. 20%) on an annual basis—capped at 75-80% max) provides the trustees and CFOs the confidence to commit capital to investments that more clearly track with the company's performance.

In an embodiment, the software is a web-based program that enables users to track FDIC insurance limits for trustees of each respective participant in the ESOP trust. The program gives the ability to proactively inform CFOs and trustees of about their capacity to buy FDIC insured financial instruments, i.e., the amount they could purchase from a specific FDIC insured institution and still know that all members of the trust are within the FDIC limits. This is extremely helpful to the trustee or CFO as they may make multiple purchases over the years from different FDIC insured institutions, multiple retirees, and multiple maturities of the different investments. This software gives the ability to push information to the trustees and CFOs—so that they are instantaneously aware of their FDIC exposure to any institution. In one embodiment, a directed custodian feature for all the FDIC investments tracks total exposure to an institution (this will additionally help when trustee needs to make distributions, etc.).

Moreover, the software is designed specifically for ESOP trusts and profit-sharing account fiduciaries. The software enables the users to inform them of their current FDIC exposure for plan participants to each respective FDIC insured institution.

The software in a further embodiment has layers of offerings, such as screening industry specific investments for the fiduciaries—where the investment tracks more closely to their respective industry, and tracking against specific inflationary indexes in their industries that could most impact the ability to meet repurchase obligations.

In an embodiment, the software is populated by the annual third-party administrator reporting for the ESOP trust or the profit sharing plan that reflects the respective participants' actuarial percentages in their account. This information or other ERISA plan data is utilized to assess the quantities of assets that can be purchased. In an alternative embodiment, actual repurchase obligation software input data could additionally be an alternative to third party administrator feeds.

A method of implementing a structured product with a bank (sometimes referred to as an insured depository institution) the earnings of which would be tied to market indexes and with the principal guaranteed by the bank and FDIC insured, embodies aspects of the invention. The potential earnings are shared between the bank and the account owner. The product according to this embodiment is a structured CD or principal protected market-linked CD, and FDIC insurance is available for the product if either (1) the company uses corporate assets to fund the product and retains the structured CD as a general asset of the company or (2) the ESOP trust uses cash balances to invest in the product. A structured CD has returns tied to selected underlying market indices and is backed by FDIC insurance. If held to maturity, return of the initial principal investment is guaranteed.

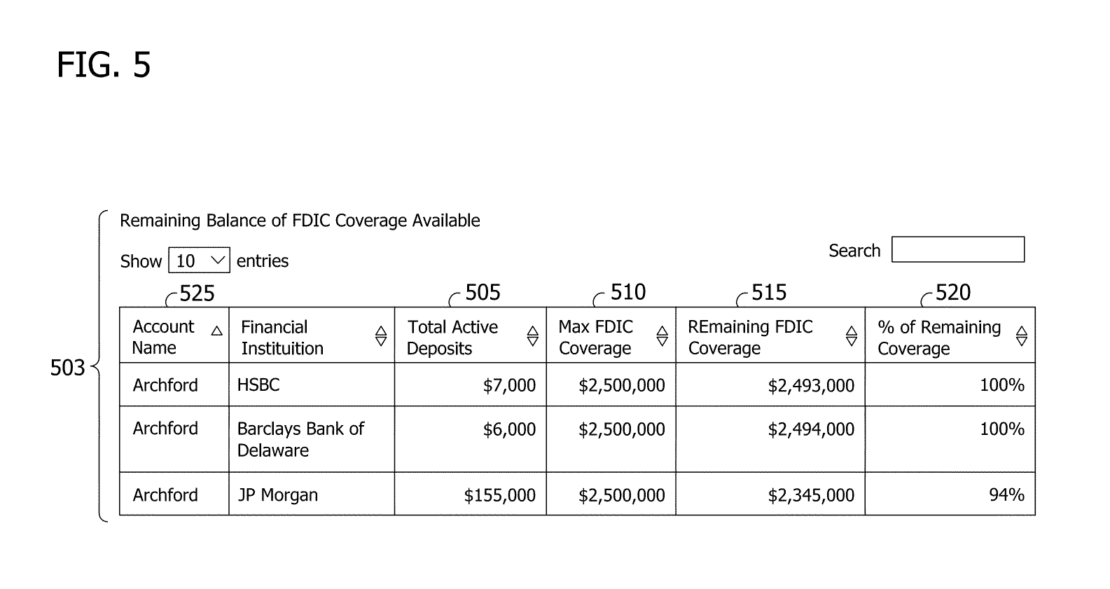

FIGS. 5-8 are exemplary screenshots, for illustrative purposes only, depicting contents of the dashboard view of a user of the web-based application according to one embodiment. In alternative embodiments, each column has filtering capabilities and the data can be exported to a spreadsheet generating application, such as Microsoft Excel.

FIG. 5 depicts a partial view 503 of an exemplary dashboard display that presents a user with a remaining balance of FDIC coverage available. The display includes, among other things, columns displaying Total Active Deposits 505, Max FDIC coverage 510, Remaining FDIC Coverage 515, and % of Remaining Coverage 520.

With reference to FIG. 5, in an embodiment, Max FDIC coverage 510 comprises an FDIC Max Coverage calculation that provides a result that can be considered the base for remaining calculations. While the FDIC Limit (i.e., $250K) remains fairly static, the census or largest owner % is the variable that consistently changes. This change can drive significant increases or decreases to an entity's available FDIC coverage per institution, resulting in a change in the Max FDIC coverage 510 displayed. A detailed excerpt of object-oriented programming code summarizing the calculation that results from accessing the various data sources as described is displayed in Appendix A. In an embodiment, Max FDIC coverage 510 data is stored in a database, such as an FDIC Max Coverage database 630 further described below.

With reference to FIG. 5, in an embodiment, Remaining FDIC coverage 515 comprises an FDIC Remaining Coverage calculation that gathers data based on other calculations (such as the FDIC Max Coverage calculation) and data gathered from databases which speaks to the criticality of the process. Based on the FDIC Max Coverage calculation 510 and the Total Active Deposits calculation 505, the remaining FDIC coverage will be identified for each FDIC insured financial institution in which the entity has deposits. A detailed excerpt of object-oriented programming code summarizing the calculation that results from accessing the various data sources as described is displayed in Appendix B. In an embodiment, Remaining FDIC coverage 515 data is stored in a database, such as an FDIC Remaining Coverage database 650.

With reference to FIG. 5, in an embodiment, each user is assigned an Account Name 525 during the user setup process. The assigned Account Name 525 assists in defining which Account information the end user will be able to view. As will be explained in further detail below, the data displayed is automatically recalculated once the Largest Owner % and Active Investments Update Process are completed. In this manner, the values associated with the most recent Ownership % and Active Investments are displayed in the partial view 503 of the dashboard display.

With reference to FIG. 5, in an embodiment, the software is also capable of highlighting a column when balances are close to FDIC insurance limits or when balances exceed FDIC insurance limits. In an embodiment, the highlighting is applied to the column depicting “% of Remaining Coverage.” In an embodiment, the column is highlighted yellow when the percentage of the remaining coverage is between 11-20%. In an embodiment, the column is highlighted red when the percentage of the remaining coverage is less than 11%.

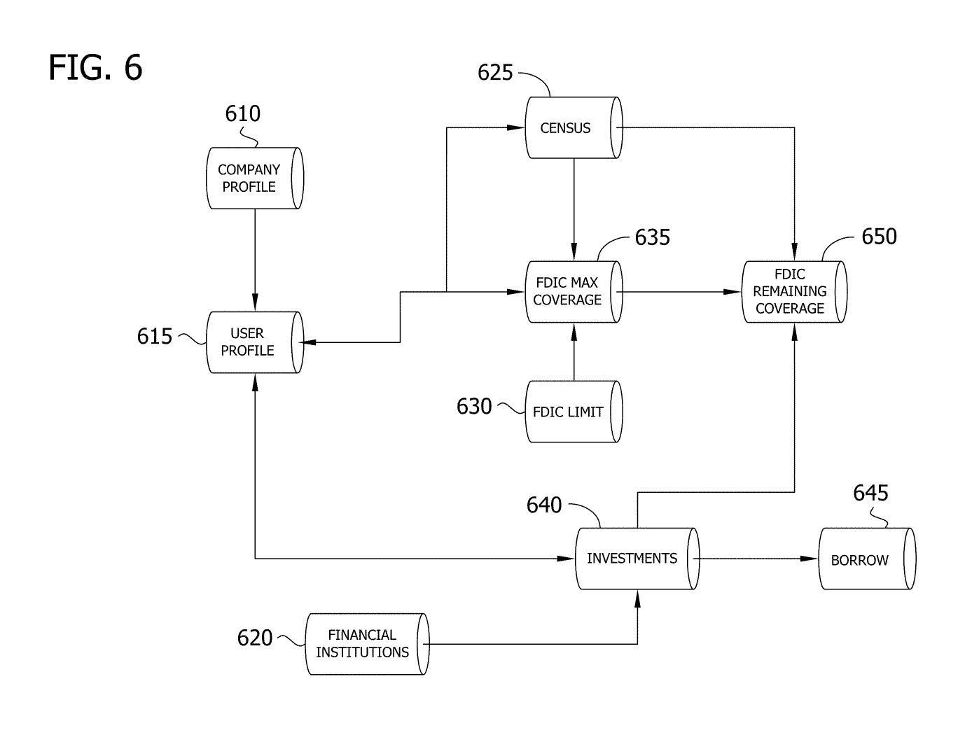

FIG. 6 is a functional diagram depicting functional relations between various databases according to embodiments of the invention. In an embodiment, the various databases store data in the forms of data tables, and the various tables have various levels of security related to entering or changing the data stored in the table. A company profile database 610 contains data related to each of the companies who have signed up to use the web-based program. The initial data will be captured in an electronic form and submitted to an administrator for approval. In an embodiment, the company profile database 610 comprises data stored in a table, and can be manually updated by a user approved to access the company name or trust, and can be updated by the administrative user.

With reference to FIG. 6, a user profile database 615 ties a User's ID to each of the companies he or she is approved to update. Multiple users can have access to multiple company names. In an embodiment, the user profile database 615 comprises data stored in a table, wherein updating the data is restricted to, for example, the administrative user. A financial institutions database 620 contains a list of current financial institutions that are covered by the FDIC. In an embodiment, the financial institutions database 620 comprises data stored in a table. Preferably, updates to the table are restricted to an administrative user or other person with sufficient rights to add new records. In an alternative embodiment, the table accepts new records via an automated interface. A census data database 625 stores data such as ownership % of ESOP trust, employee age, Social Security number, date of birth, date of hire, total number of participants, etc. In an embodiment, data entered into the census data database 625 is stored in a table, and is editable by accepting new records from end users or administrators.

Still referring to FIG. 6, an FDIC limit database 630 and the FDIC max coverage database function together to determine the maximum dollar amount that a company or trust can deposit in a FDIC financial institution and still be covered under the FDIC insurance limits. In an embodiment, the calculation requires at least two tables stored in two databases; the first table comprises FDIC limit data entered into the FDIC limit database 630. The existing values in the table storing data in the FDIC limit database 630 are, for example, not updatable. As such, only new values can be added in this instance. In another embodiment, access to the table is restricted to administrators. An FDIC max coverage database 635, which contains the results of a calculation of the maximum dollar amount that a company or trust can deposit in a FDIC financial institution and still be covered under the FDIC insurance limits, comprises the second table required for the calculation. In an embodiment, the table is not directly editable by any end user.

Referring further to FIG. 6, an investments database 640 contains data related to capturing a company's investment information. In addition, the investments database 640 is configured to allow users to update their investments as well. In an embodiment, the investments database 640 comprises data stored in a table that is displayed to the user and has filtering capacity. The data stored in the table relating to the investments database 640 accepts new records by, for example, end users or an administrator. According to embodiments of the invention, user profile database 615 is configured to have a validation relationship with the census database 625, FDIC max coverage database 635, and investments database 640.

A borrow database 645 stores data related to providing a company with the capability of borrowing against its own investments. And an FDIC remaining coverage database 650 accepts new records through an updating process whereby the active investments of the user are saved. According to embodiments of the invention, the borrow database 645 is configured to have a data reference relationship from the investments database 640. Similarly, investments database 640 is configured to have a data reference relationship from the financial institutions database 620. And the FDIC remaining coverage database 650 is configured to have a data reference relationship from census database 625, FDIC max coverage database 635, and investments database 640 and the FDIC max coverage database 635 is configured to have a data reference relationship from the FDIC limit database 630 and census database 625.

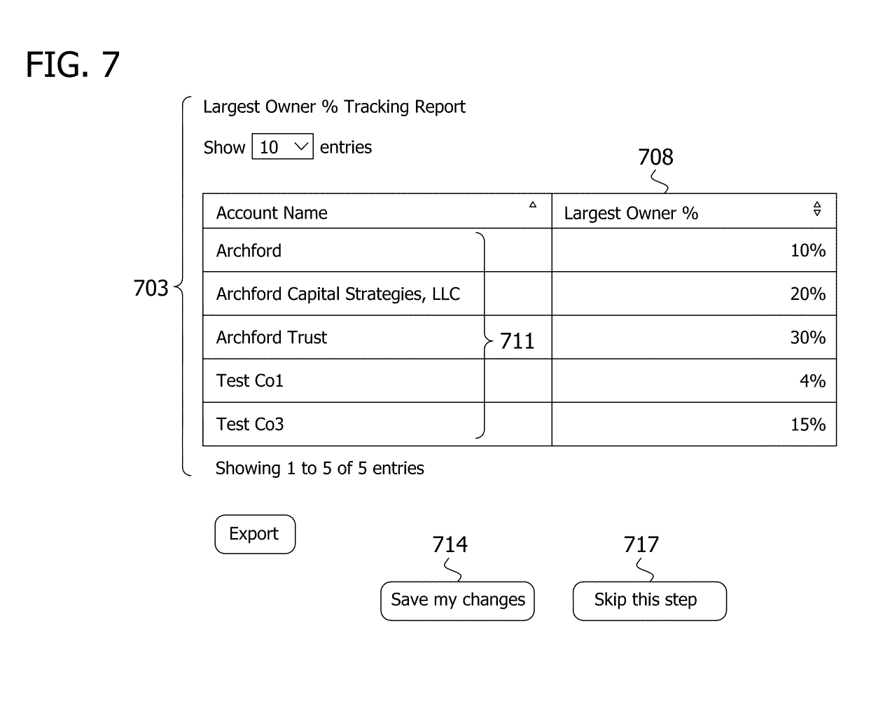

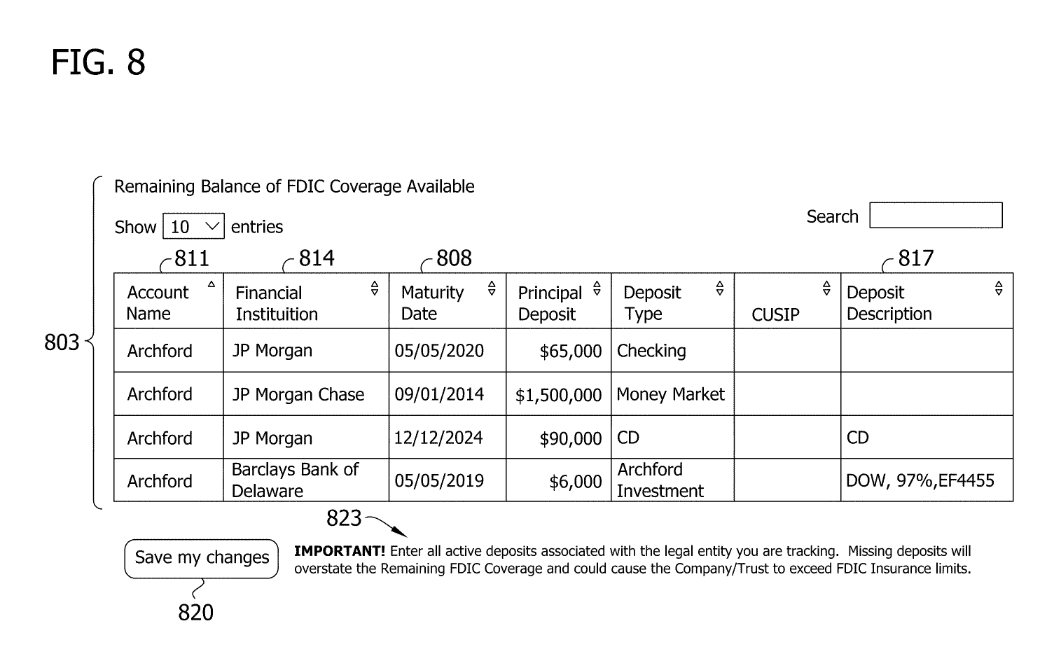

FIG. 7 depicts a partial view 703 of an exemplary dashboard display that presents a user with, among other parameters, the Largest Owner Percentage 708, which is the percentage of the plan assets owned by the employee with the largest account. The Largest Owner Percentage 708 associated with each Account Name 711 determines the total available FDIC coverage. This information is useful at least because, as previously explained, for plan accounts eligible for pass-through coverage, the percentage of plan assets owned by the employee with the largest account determines the maximum amount the plan can deposit at one bank and still be fully insured.

With reference to FIG. 7, Step 1 of the “Owner % and Active Investments Updates Process” is accomplished by updating the Largest Owner Percentage 708 values in the partial view 703 of the dashboard display. In an embodiment, values can be copied from a spreadsheet generation program, such as Microsoft Excel. In an embodiment, the copied values must exactly match the Account Name 711 and must be ordered in the exact order displayed in the partial view 703 of the dashboard display.

With further reference to FIG. 7, in an embodiment, upon the user clicking a “Save my changes,” button 714, a record will be written to a database and the user will be taken to Step 2 of the “Owner % and Active Investments Updates Process,” further described with reference to FIG. 8 below. Upon clicking a “Skip this step” button 717, the user is taken directly to Step 2, without writing a record to a database. In an embodiment, each field displayed in a column will include a description of the data to include.

FIG. 8 depicts an exemplary dashboard display 803 of a report of all active deposits with FDIC coverage that the user is tracking. The Maturity Date 808 of an investment account indicates the date the principal amount is returned to the investor and is identified by, among other descriptive indicators, the Account Name 811, the Financial Institution 814, and the Deposit Description 817. In an embodiment, the software is capable of highlighting deposits/investments with a Maturity Date 808 in the past, indicating the user should update their active deposits. In an embodiment, a warning note indicating that the investment has passed its maturity date and an option to update the relevant data by clicking a button on the display accompanies the highlighted Maturity Date 808.

With reference to FIG. 8, Step 2 of the “Owner % and Active Investments Updates Process” is accomplished by adding or updating information pertaining to FDIC covered investments to the depiction of FIG. 8. In an embodiment, values can be copied from a spreadsheet generation program, such as Microsoft Excel. In an embodiment, the copied values must exactly match the Account Name 811 and must be ordered in the exact order displayed in the partial view 803 of the dashboard display.

With further reference to FIG. 8, upon clicking a “Save my changes” button 820, a database is updated based on the newly entered information. In an embodiment, a warning message 823 is displayed during Step 2 of the “Owner % and Active Investments Updates Process.”

FIG. 9 depicts a partial view 903 of an exemplary dashboard display that provides a user with the capability of adding new largest owner records to a plan. For each newly entered account, the Account Name 906, the Largest Owner Percent 911, and the Plan Year 914 may be specified by the user.

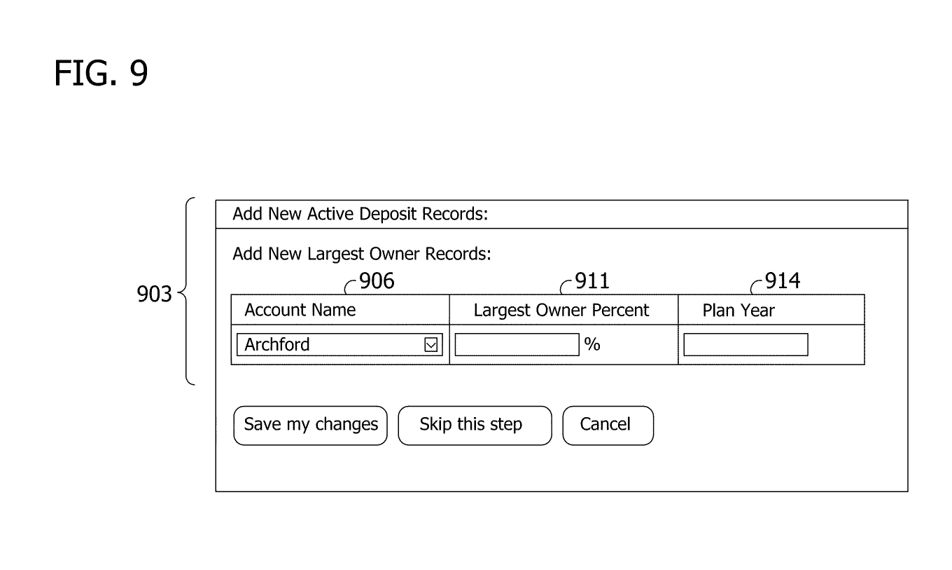

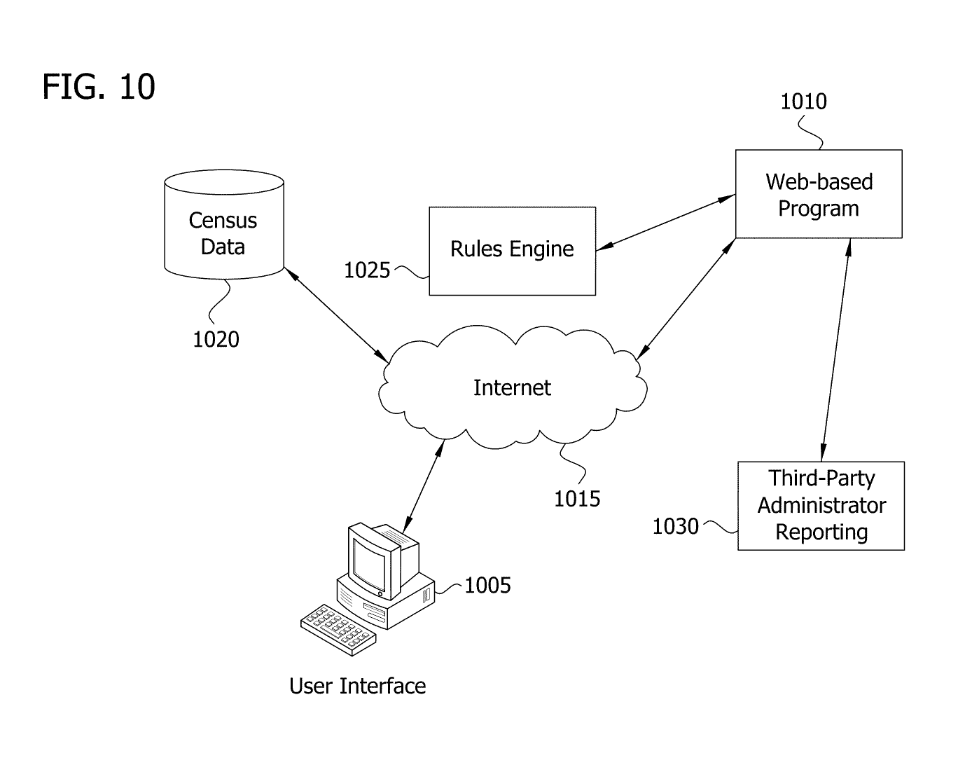

FIG. 10 depicts various components functionally related in one embodiment of the claimed invention. More specifically, a user interface 1005 interfaces with a web-based program 1010 capable of identifying available insurance coverage to the participants of a customized financial product plan. In an embodiment, the web-based program 1010 is provided via the internet 1015 or “cloud”. In an embodiment, census data database 1020 stores census data related to participants of the customized financial product plan, and makes the data available to the web-based program 1010 via the internet 1015.

Referring further to FIG. 10, in an embodiment, census data is provided to the census data database 1020 when a user interfaces with the user interface 1005. In other embodiments, data is provided in other ways, such as by capturing the census data in a yearly survey, or by gathering current status data using the web-based program 1010, as two non-limiting examples. In an embodiment, a rules engine 1025 interacts with the web-based program 1010 to execute rules to determine insurance coverage limit data for product plan participants. In a further embodiment, the web-based program 1010 determines maximum balance data comprising a maximum balance able to be held as a function of the collected census data maintained by the census data database 1020 and provided to the web-based program 1010 via the internet 1015.

Still referring to FIG. 10, in a further embodiment, the maximum balance data determined as a function of the collected census data 1020 provided to the web-based program 1010 via the internet 1015 is combined with the determined insurance coverage limit data determined by the interaction between the web-based program 1010 and the rules engine 1025 and the gathered current status data gathered using the web-based program 1010 to yield a remaining balance able to be deposited without exceeding FDIC account limits. In a further embodiment, the web-based program 1010 is populated by third-party administrator reporting 1030. In a further embodiment, third-party administrator reporting 1030 further comprises the annual third-party administrator reporting for the ESOP trust or the profit sharing plan that reflects the respective participants' actuarial percentages in their account.

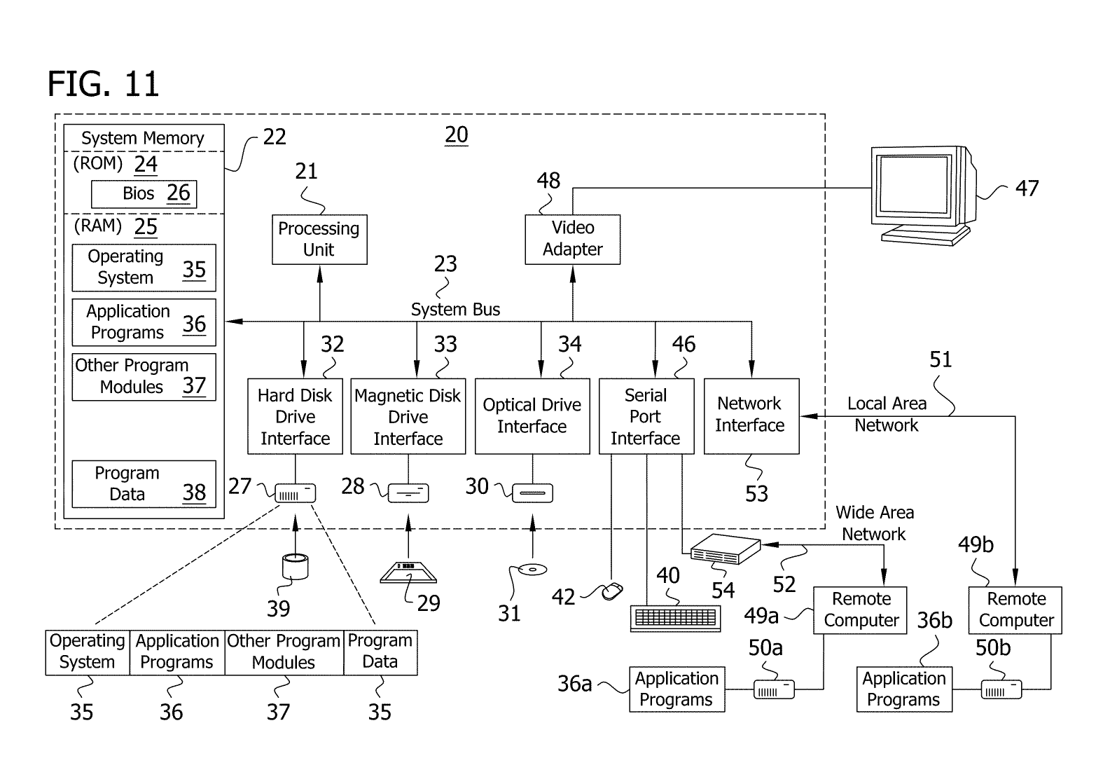

FIG. 11 and the following discussion are intended to provide a brief, general description of a suitable computing environment in which aspects of the invention may be implemented. Although not required, aspects of the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the invention may be practiced in network computing environments with many types of computer system configurations, including personal computers, hand-held devices, multi-processor systems, microprocessor-based or programmable consumer electronics, network PCs, minicomputers, mainframe computers, and the like. Aspects of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 11, an exemplary system for implementing aspects of the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory 22 includes read only memory (ROM) 24 and random access memory (RAM) 25. A basic input/output system (BIOS) 26, containing the basic routines that help transfer information between elements within the computer 20, such as during start-up, may be stored in ROM 24. Further, the computer 20 may include any device (e.g., computer, laptop, tablet, PDA, cell phone, mobile phone, a smart television, and the like) that is capable of receiving or transmitting an IP address wirelessly to or from the internet.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules, and other data for the computer 20. Although the exemplary environment described herein employs a magnetic hard disk 39, a removable magnetic disk 29, and a removable optical disk 31, other types of computer readable media for storing data can be used, including magnetic cassettes, flash memory cards, digital video disks, Bernoulli cartridges, RAMs, ROMs, and the like.

Computer 20 typically includes a variety of computer readable media. Computer readable media can be any available media that can be accessed by computer 20 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media is non-transitory and includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired non-transitory information, which can accessed by computer 20. Alternatively, communication media typically embodies computer readable instructions, data structures, program modules or other data in a modulated data signal such as a carrier wave or other transport mechanism and includes any information delivery media.

Program code means comprising one or more program modules may be stored on the hard disk 39, magnetic disk 29, optical disk 31, ROM 24, and/or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port, or a universal serial bus (USB). A monitor 47 or another display device is also connected to system bus 23 via an interface, such as video adapter 48. In addition to the monitor, personal computers typically include other peripheral output devices (not shown), such as speakers and printers.

One or more aspects of the invention may be embodied in computer-executable instructions (i.e., software), routines, or functions stored in system memory 22 or non-volatile memory 27, 29, 31 as application programs 36, program modules 37 and/or program data 35, 38. The software may alternatively be stored remotely, such as on remote computer 49a, 49b with remote application programs 36a, 36b. Generally, program modules include routines, programs, objects, components, data structures, etc. that perform particular tasks or implement particular abstract data types when executed by a processor in a computer or other device. The computer executable instructions may be stored on a computer readable medium such as a hard disk 27, 39, optical disk 31, removable storage media 29, solid state memory, RAM 25, etc. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer 20 may operate in a networked environment using logical connections to one or more remote computers, such as remote computers 49a and 49b. Remote computers 49a and 49b may each be another personal computer, a tablet, a PDA, a server, a router, a network PC, a peer device or other common network node, and typically include many or all of the elements described above relative to the computer 20, although only memory storage devices 50a and 50b and their associated application programs 36a and 36b have been illustrated in FIG. 11. The logical connections depicted in FIG. 10 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

Preferably, computer-executable instructions are stored in a memory, such as hard disk drive 27, and executed by computer 20. Advantageously, the computer processor has the capability to perform all operations (e.g., execute computer-executable instructions) in real-time.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

APPENDIX A
FDIC Max Coverage Calculation

```
/**
* Calculates the maximum coverage based on the coverage limit and
max owner percent
* @param array|float $max_owner_percent
* @return float
*/
function max_coverage($max_owner_percent) {
    $max_coverage = NULL;
    $coverage_limit = $this->adminModel->get_coverage_limit( );
    if ( ! empty($max_owner_percent)) {
        if (is_array($max_owner_percent)) {
            $max_owner_percent =
$max_owner_percent[0][‘largest_owner_percent’];
        }
        $max_coverage = $coverage_limit / $max_owner_percent;
    }
    return $max_coverage;
}
```

APPENDIX B
FDIC Remaining Coverage Calculation

```
/**
* Retreive the investment records with the data prepared for
display.
* This includes the remaining coverage information, which is then
* displayed via further calculations.
*
* @return array
*/
public function get_maxcoverage_records( ) {
  $investments = $this->get_active_investments( );
  $return_records = array( );
  if ($investments) {
    foreach ($investments AS $investment) {
      extract($investment);
      $return_records[$company_name][‘company_id’] =
$company_id;
      if (isset($investment[‘owner_info’])) {
        $return_records[$company_name][‘owner_info’] =
$investment[‘owner_info’];
      }
  $return_records[$company_name][‘institutions’][$financial_institution
][$investment_type] = $investment;
    }
  }
  $investments = $this->get_total($return_records);
  $return_records = array( );
  if ($investments) {
    foreach ($investments AS $company => $company_info) {
      $max_owner_percent =
(isset($company_info[‘owner_info’]))
        ? $company_info[‘owner_info’]
```

| | |
|---|---|
| : array ( ‘largest_owner_percent’ | => |
| 0, | |
| ‘plan_year’ | => |
| ‘’, | |
| ‘message’ | => |

```
‘No Largest Owner Record Set Yet.’
        );
      foreach($company_info[‘institutions’] AS
$institution => $investments) {
        foreach($investments AS $investment => $data)
{
  $return_records[$company][‘institutions’][$institution][$investment
] = $data;
          $max_coverage = $this->LoansModel-
>max_coverage($max_owner_percent[‘largest_owner_percent’]);
          $return_records[$company][‘max_coverage’]
= $max_coverage;
          $return_records[$company][‘plan_year’] =
$max_owner_percent[‘plan_year’];
  $return_records[$company][‘institutions’][$institution][‘last_{—}
modified’] = $investments[‘last_date’];
  $return_records[$company][‘institutions’][$institution][‘remaining
_coverage’] = $max_coverage − $investments[‘total’];
          $return_records[$company][‘message’] =
(isset($max_owner_percent[‘message’])) ?
$max_owner_percent[‘message’] : ‘’;
        }
      }
    }
  }
  return $return_records;
}
/**
* Display the records, including the calculated remaining coverage
percent.
*/
foreach ($remaining_balance_records AS $company => $institutions) {
  $info = array( );
  $info[‘max_coverage’] = $institutions[‘max_coverage’];
  $info[‘plan_year’] = $institutions[‘plan_year’];
  foreach($institutions[‘institutions’] AS $institution =>
$data)  {
  $percent =
number_format((Html::divide($data[‘remaining_coverage’],
$info[‘max_coverage’]) * 100), 0);
    $row_class = ($percent < 20) ? ‘warning’ : ‘’;
    $row_class = ($percent < 11) ? ‘danger’ : $row_class;
    $message = ( isset($institutions[‘message’])) ?
$institutions[‘message’] : ‘’;
    // Output records here to browser
  }
}
```

What is claimed is:

1. A computer-implemented method for operating a customized financial product plan for a sponsoring company, the method comprising the steps of:
identifying available insurance coverage to the participants of the customized financial product plan;
collecting census data related to the participants of the customized financial product plan;
determining maximum balance data, wherein the maximum balance data further comprises a maximum balance able to be held as a function of the collected census data;
executing rules for determining insurance coverage limit data for product plan participants based on the identified coverage;
gathering current status data related to customized financial products;
processing, by a computer processor coupled to a memory, the maximum balance data with the determined insurance coverage limit data and the gathered current status data to yield a remaining balance able to be deposited without exceeding FDIC account limits;
rendering a first value representing the future cash flow of the product plan defined at least in part by the combined remaining balance and based on a natural maturity of the investment;
rendering a second value representing the future cash flow available to the product plan defined at least in part by the processed remaining balance and based on borrowing against trust assets;
assigning a score representing the ability of the product plan to meet future repurchase obligations based on the first and second values; and
providing an output on a dashboard representative of the assigned score.

2. The method of claim 1, wherein the product plan participants have ascertainable, non-contingent interests in the plan.

3. The method of claim 1, wherein the census data related to the customized financial product plan further comprises one or more of the following: ownership percentage of Employee Stock Ownership Plan (ESOP) trust, employee age, social security number, date of birth, date of hire, and total number of participants.

4. The method of claim 1, wherein the maximum balance able to be held comprises a deposit of a sponsoring company in a federally insured financial institution, said deposit not exceeding federal insured account limits.

5. The method of claim 4, wherein the deposit further comprises an investment in a structured certificate of deposit (CD) with the general assets of the company.

6. The method of claim 5, further comprising retaining ownership of the structured CD in the name of the company.

7. The method of claim 4, wherein the current status data related to customized financial products comprises status data held in each federally insured financial institution and held by each product plan participant.

8. The method of claim 1, wherein the product is issued on a monthly basis.

9. A tangible processor-readable memory storing processor-executable instructions to operate a customized financial product plan for a sponsoring company, said instructions, when executed by the processor, enabling an operation on a user interface in which results are displayed and selected on an application dashboard, said instructions comprising:
identifying instructions for identifying available insurance coverage to the participants of the customized financial product plan;
collecting instructions for collecting census data related to the participants of the customized financial product plan;
determining instructions for determining maximum balance data, wherein the maximum balance data further comprises a maximum balance able to be held as a function of the collected census data;
executing instructions for executing rules for determining insurance coverage limit data for product plan participants based on the identified coverage;
gathering instructions for receiving current status data related to customized financial products;
combining instructions for combining, by a computer processor coupled to a memory, the maximum balance data with the determined insurance coverage limit data and the gathered current status data to yield a remaining balance able to be deposited without exceeding insurance coverage limits;
rendering instructions for rendering a first value representing the future cash flow of the product plan defined at least in part by the combined remaining balance and based on a natural maturity of the investment;
rendering instructions for rendering a second value representing the future cash flow available to the product plan defined at least in part by the combined remaining balance and based on borrowing against trust assets;
assigning instructions for assigning a score representing the ability of the product plan to meet future repurchase obligations based on the first and second values; and
providing instructions for generating an output on a dashboard representative of the assigned score.

10. The memory of claim 9, wherein the participants of the customized product plan have ascertainable, non-contingent interests in the plan.

11. The memory of claim 9, wherein the census data related to the customized financial product plan further comprises one or more of the following: ownership percentage of Employee Stock Ownership Plan (ESOP) trust, employee age, social security number, date of birth, date of hire, and total number of participants.

12. The memory of claim 9, wherein the deposit further comprises an investment in a structured certificate of deposit (CD) with the general assets of the company.

13. The memory of claim 12, further comprising retaining ownership of the structured CD in the name of the company.

14. The memory of claim 9, wherein the current status data related to customized financial products comprises status data held in each of a plurality of federally insured financial institutions and held by each product plan participant.

15. The memory of claim 9, wherein the product is issued on a monthly basis.

16. A computer-implemented method for operating a customized financial product plan for a sponsoring company, the method comprising the steps of:
identifying available insurance coverage to the participants of the customized financial product plan;
collecting census data related to the participants of the customized financial product plan;
determining maximum balance data, wherein the maximum balance data further comprises a maximum balance able to be held as a function of the collected census data;
executing rules for determining insurance coverage limit data for product plan participants based on the identified coverage;
gathering current status data related to customized financial products; and
combining, by a computer processor coupled to a memory, the maximum balance data with the determined insurance coverage limit data and the gathered current status data to yield a remaining balance able to be deposited without exceeding insurance coverage limits.

17. The method of claim 16, further comprising:
rendering a first value representing the future cash flow of the product plan defined at least in part by the combined remaining balance and based on a natural maturity of the investment;
rendering a second value representing the future cash flow available to the product plan defined at least in part by the combined remaining balance and based on borrowing against trust assets;
assigning a score representing the ability of the product plan to meet future repurchase obligations based on the first and second values; and
providing an output on a dashboard representative of the assigned score.

18. A computer implemented system to operate a customized financial product plan for a sponsoring company, the system comprising:
a user interface in which calculation values are displayed as an output on an application dashboard;
a processor capable of executing computer-executable instructions;
a memory device coupled to the processor; and
computer-executable instructions stored on the memory device, wherein the instructions, when executed by the processor, operate the customized financial product plan, comprising:
identifying available insurance coverage to the participants of the customized financial product plan;
collecting census data related to the participants of the customized financial product plan;
determining maximum balance data, wherein the maximum balance data further comprises a maximum balance able to be held as a function of the collected census data;
executing rules for determining insurance coverage limit data for product plan participants based on the identified coverage;
gathering current status data related to customized financial products;
combining, by a computer processor coupled to a memory, the maximum balance data with the determined insurance coverage limit data and the gathered current status data to yield a remaining balance able to be deposited without exceeding FDIC account limits;
rendering a first value representing the future cash flow of the product plan defined at least in part by the combined remaining balance and based on a natural maturity of the investment;
rendering a second value representing the future cash flow available to the product plan defined at least in part by the combined remaining balance and based on borrowing against trust assets;
assigning a score representing the ability of the product plan to meet future repurchase obligations based on the first and second values; and
providing an output on a dashboard representative of the assigned score.

19. A computer system for operating a customized financial product plan for a sponsoring company, the system comprising:
a database storing census data related to participants of the customized financial product plan;
a computer implemented user interface configured to provide census data to the database and to display a result on the interface, the census data related to identifying available insurance coverage to the participants of the customized financial product plan;
a rules engine configured to execute rules to determine insurance coverage limit data for product plan participants;
a third-party administrator reporting processing module configured to report account data related to the participants of the customized financial product plan; and,
a web-based program, executed by at least one computer system having at least one computer processor, electronically retrieving census data from the database related to participants of the customized financial product plan and provided by to the database via the user interface, and electronically interacting with the rules engine to determine insurance coverage limit data, and electronically receiving account data from the third-party administrator reporting processing module, and electronically processing a result reflecting the identification of available insurance coverage to the participants of the customized financial product plan as a function of the provided census data, the determined insurance coverage limit data, and the account data.

20. The system of claim 19, wherein the result further comprises a remaining balance able to be deposited without exceeding federally insured account limits.

21. The system of claim 19, wherein the census data further comprises one or more of the following: ownership percentage of Employee Stock Ownership Plan (ESOP) trust, employee age, social security number, date of birth, date of hire, and total number of participants.

22. The system of claim 19, wherein the web based program further comprises electronically gathering current status data related to customized financial products.
